(19) United States
(12) Patent Application Publication
(10) Pub. No.: US 2024/0388786 A1
(43) Pub. Date: Nov. 21, 2024

(54) METHOD FOR OPERATING A GATED CAMERA, CONTROL DEVICE FOR CARRYING OUT SUCH A METHOD, GATED CAMERA WITH SUCH A CONTROL DEVICE, AND MOTOR VEHICLE WITH SUCH A GATED CAMERA

(71) Applicant: Daimler Truck AG, Leinfelden-Echterdingen (DE)

(72) Inventor: Fridtjof STEIN, Ostfildern (DE)

(21) Appl. No.: 18/689,749

(22) PCT Filed: Aug. 23, 2022
(86) PCT No.: PCT/EP2022/073367

§ 371 Date: Mar. 6, 2024

(30) Foreign Application Priority Data
Sep. 7, 2021 (DE) 10 2021 004 516.5

(51) Int. Cl. H04N 23/56

(52) U.S. Cl. CPC H04N 23/56

(57) ABSTRACT

The invention relates to a method for operating a gated camera (3) having an illumination device (5) and an optical sensor (7), wherein
the illumination device (5) and the optical sensor (7) are time-coordinated with each other, wherein
a visible distance range is assigned to a first time coordination, wherein
a property (25) of the visible distance range is provided, wherein
the illumination device (5) has at least two functional positions (11), so that the visible distance range can be selectively illuminated by means of the illumination device (5) from at least one functional position (11) of the at least two functional positions (11), wherein
the at least two functional positions (11) are spatially distanced from one another, wherein
based on the property (25) of the visible distance range, a functional position (11) of the at least two functional positions (11) for illuminating the visible distance range is selected.

The invention relates to a method for operating a gated camera, a control device for carrying out such a method, a gated camera with such a control device, and a motor vehicle with such a gated camera.

Methods are known, particularly for motor vehicles, in which objects are detected using a gated camera. Preferably, a shadow cast by the object to be detected is used to detect the object easily and reliably. The detection of objects improves the more pronounced, and in particular the longer, the shadow cast. For a well-defined shadow cast, in particular a long shadow cast, an illumination element must be arranged as low as possible in a vertical direction, in particular at the smallest possible distance from a road surface on which the motor vehicle is travelling. The disadvantage of arranging the illumination element as low as possible in this way is that an uneven road surface also casts a long shadow and, in the worst case, covers an object and its shadow so that the object cannot be detected.

The object of the invention is therefore to create a method for operating a gated camera, a control device for carrying out such a method, a gated camera with such a control device, and a motor vehicle with such a gated camera, wherein the disadvantages mentioned are at least partially eliminated, preferably avoided.

The object is achieved by providing the present technical teaching, in particular the teaching of the independent claims and the embodiments disclosed in the dependent claims and the description.

The object is achieved in particular by creating a method for operating a gated camera which has an illumination device and an optical sensor. The illumination device and the optical sensor are controlled in a time-coordinated manner, wherein a visible distance range is assigned to a time coordination. In addition, a property of the visible distance range is provided. The illumination device has at least two functional positions, so that the visible distance range can be illuminated by means of the illumination device optionally from at least one functional position of the at least two functional positions, wherein the at least two functional positions are spatially distanced from one another. Furthermore, based on the property of the visible distance range, a functional position of the at least two functional positions is selected for illuminating the visible distance range.

Advantageously, this makes it possible to illuminate the visible distance range from the at least two different functional positions and thus ensure safe and reliable detection of objects in the visible distance range, particularly depending on the properties of the visible distance range.

In a preferred embodiment, a first image is recorded by means of the timed control, wherein the property of the visible distance range is determined using the first image. Alternatively or additionally, preferably after the selection of the functional position for illuminating the visible distance range, a second image is recorded by means of the time control, wherein an object detection process is preferably carried out using the second image.

In a further preferred embodiment, the property of the visible distance range is received by the gated camera, in particular wirelessly. In a particularly preferred embodiment, the gated camera receives the property of the visible distance range from a computer centre and/or a navigation system.

Preferably, the visible distance range is illuminated from one functional position of the at least two functional positions depending on the property of the visible distance range. Alternatively or additionally, the visible distance range is illuminated alternately from different functional positions of the at least two functional positions depending on the property of the visible distance range.

The method for generating images by means of a time-coordinated control of an illumination device and an optical sensor is, in particular, a method known as a gated imaging method; in particular, the optical sensor is a camera that is only switched sensitively in a specific, restricted time range, which is referred to as “gated control”, i.e. the camera is a gated camera. Accordingly, the illumination device is also only controlled in a specific, selected time interval in order to illuminate an object-side scene, in particular the visible distance range.

In particular, the illumination device emits a predefined number of light pulses, preferably each with a duration of between 5 ns and 20 ns. The start and end of the exposure of the optical sensor is coupled to the number and duration of the emitted light pulses and a start of the illumination. As a result, a specific visible distance range can be detected by the optical sensor through the time control of the illumination device on the one hand and the optical sensor on the other with a correspondingly defined local position, i.e. in particular at specific distances of a near and a far limit of the visible distance range from the optical sensor. A local position of the optical sensor and the illumination device is known from the structure of the gated camera. Preferably, a local distance between the illumination device and the optical sensor is also known and is small compared to the distance between the illumination device or the optical sensor and the visible distance range. Thus, in the context of the present technical teaching, a distance between the optical sensor and the visible distance range is equal to a distance between the gated camera and the visible distance range.

The visible distance range is that-object-side-range in three-dimensional space which is mapped in a two-dimensional image on an image plane of the optical sensor by the number and duration of the light pulses of the illumination device and the start of the illumination in conjunction with the start and end of the exposure of the optical sensor by means of the optical sensor.

By contrast, the observation area is in particular the-object-side-area in three-dimensional space that could be imaged as a whole-in particular maximally-in a two-dimensional image by means of the optical sensor if the optical sensor is sufficiently illuminated and exposed. In particular, the observation area corresponds to the entire exposable image area of the optical sensor that could theoretically be illuminated. The visible distance range is therefore a subset of the observation area in real space. Accordingly, only a subset of the image plane of the optical sensor is also exposed in the method proposed here, wherein this subset of the image plane is given in particular between a start image line and an end image line.

Where the term “object-side” is used here and in the following, this refers to an area in real space. Where the term “image-side” is used here and in the following, this refers to an area on the image plane of the optical sensor. The observation area and the visible distance range are given here on the object side. They correspond to image-side areas on the image plane assigned by the imaging laws and the time control of the illumination device and the optical sensor.

Depending on the start and end of the exposure of the optical sensor after the start of illumination by the illumination device, light pulse photons hit the optical sensor. The further the visible distance range is from the illumination device and the optical sensor, the longer the time it takes for a photon that is reflected in this distance range to hit the optical sensor. The further the visible distance range is from the illumination device and the optical sensor, the longer the time interval between the end of the illumination and the start of the exposure.

According to one embodiment of the method, it is therefore possible in particular to define the position and the spatial width of the visible distance range, in particular a distance between the near limit and the far limit of the visible distance range, by selecting the appropriate time control of the illumination device on the one hand and of the optical sensor on the other.

In a preferred embodiment of the method, the visible distance range is specified, wherein the time coordination of the illumination device on the one hand and of the optical sensor on the other hand is specified accordingly.

In a further preferred embodiment of the method, the time coordination of the illumination device on the one hand and of the optical sensor on the other hand is predetermined, wherein the visible distance range is predetermined accordingly.

In a preferred embodiment, the illumination device has at least one surface emitter, in particular a so-called VCSE laser, preferably a plurality of surface emitters, in particular a plurality of VCSE lasers. Alternatively or additionally, the optical sensor is preferably a camera.

Advantageously, the method can be carried out continuously.

According to a development of the invention, it is provided that the at least one illumination device comprises an illumination element, wherein the illumination element is selectively displaced into one of the at least two functional positions based on the property of the visible distance range.

Advantageously, this makes it possible to illuminate the visible distance range from the at least two different functional positions by means of a single illumination element.

Preferably, the illumination device has exactly two functional positions, wherein the one illumination element can be arranged discretely and selectively in one functional position of the exactly two functional positions. Alternatively or additionally, the one illumination element can preferably be displaced in discrete steps between the at least two functional positions, so that the one illumination element can advantageously be arranged in a plurality of functional positions. Alternatively or additionally, the one illumination element can be displaced continuously between the at least two functional positions, so that the one illumination element can advantageously be arranged at any functional position between the at least two functional positions.

According to a development of the invention, it is provided that the at least one illumination device has at least two illumination elements. A first illumination element of the at least two illumination elements is arranged in a first functional position of the at least two functional positions. A second illumination element of the at least two illumination elements is arranged in a second functional position of the at least two functional positions. Based on the property of the visible distance range, the first illumination element or the second illumination element is controlled to illuminate the visible distance range.

Advantageously, this makes it possible to illuminate the visible distance range from the at least two different functional positions without a displacement mechanism.

According to a development of the invention, it is provided that a vertical deviation of a surface to be observed, in particular a road to be observed, from a horizontal course is used as the property of the visible distance range.

Preferably, the bottom functional position of the at least two functional positions in the vertical direction is used as the standard functional position, in particular if there is no vertical deviation of the surface to be observed from the horizontal course. Alternatively or additionally, the at least one further functional position of the at least two functional positions is used as an additional functional position, in particular if there is a vertical deviation of the surface to be observed from the horizontal course.

According to a development of the invention, it is provided that the at least two functional positions are vertically spaced apart from one another. Advantageously, it is thus possible in a simple manner to shorten a shadow cast by the vertical deviation of the surface to be observed, in particular of the road to be observed, from the horizontal course and thus ensure reliable object detection.

The problem is also solved by creating a control device which is set up to carry out a method according to the invention or a method according to one or more of the embodiments described above. In particular, the advantages already explained in conjunction with the method arise in conjunction with the control device.

The control device is preferably set up to be operatively connected to the illumination device and the optical sensor and set up for their respective control. In addition, the control device is preferably set up to cause a displacement of the one illumination element of the illumination device. Alternatively or additionally, the control device is preferably set up to control the at least two illumination elements of the illumination device alternately or simultaneously. Alternatively or additionally, the control device is preferably set up to receive the property of the visible distance range from a computer centre and/or a navigation system.

The problem is also solved by creating a gated camera which has an illumination device, an optical sensor and a control device according to the invention or a control device according to one or more of the embodiments described above. In addition, the illumination device has at least two functional positions, wherein the at least two functional positions are spatially, in particular vertically, spaced apart from one another. The advantages already explained in conjunction with the method and the control device arise in particular in conjunction with the gated camera.

The control device is preferably operatively connected to the illumination device and the optical sensor and is set up to control them respectively.

According to a development of the invention, it is provided that the illumination device has an illumination element, wherein the illumination element is displaceable between the at least two functional positions.

According to a development of the invention, it is provided that the illumination device has at least two illumination elements, wherein one illumination element is arranged in each functional position.

Preferably, a first illumination element of the at least two illumination elements is arranged in a first functional position of the at least two functional positions. Alternatively or additionally, a second illumination element of the at least two illumination elements is preferably arranged in a second functional position of the at least two functional positions.

The problem is also solved by creating a motor vehicle with a gated camera according to the invention or a gated camera according to one or more of the embodiments described above. In particular, the advantages already explained in conjunction with the method, the control device and the gated camera arise in conjunction with the motor vehicle.

In a preferred embodiment, the motor vehicle is designed as an autonomously travelling motor vehicle. Alternatively or additionally, the motor vehicle is preferably designed as a lorry. However, it is also possible for the motor vehicle to be designed as a passenger car, a commercial vehicle or another motor vehicle.

The invention is explained in greater detail below with reference to the drawings.

In the drawings:

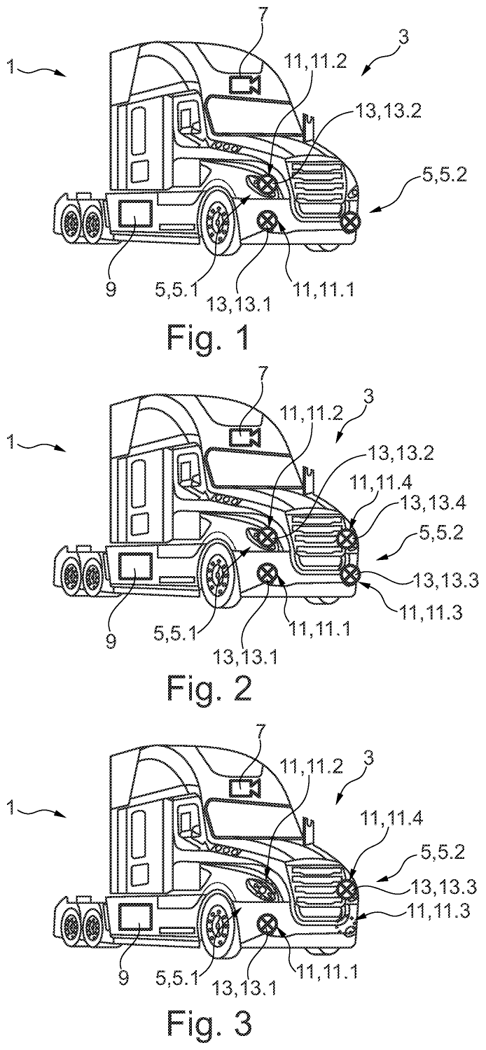

FIG. 1 shows a schematic representation of a first exemplary embodiment of a motor vehicle,

FIG. 2 shows a schematic representation of a second exemplary embodiment of the motor vehicle,

FIG. 3 shows a schematic representation of a third exemplary embodiment of the motor vehicle,

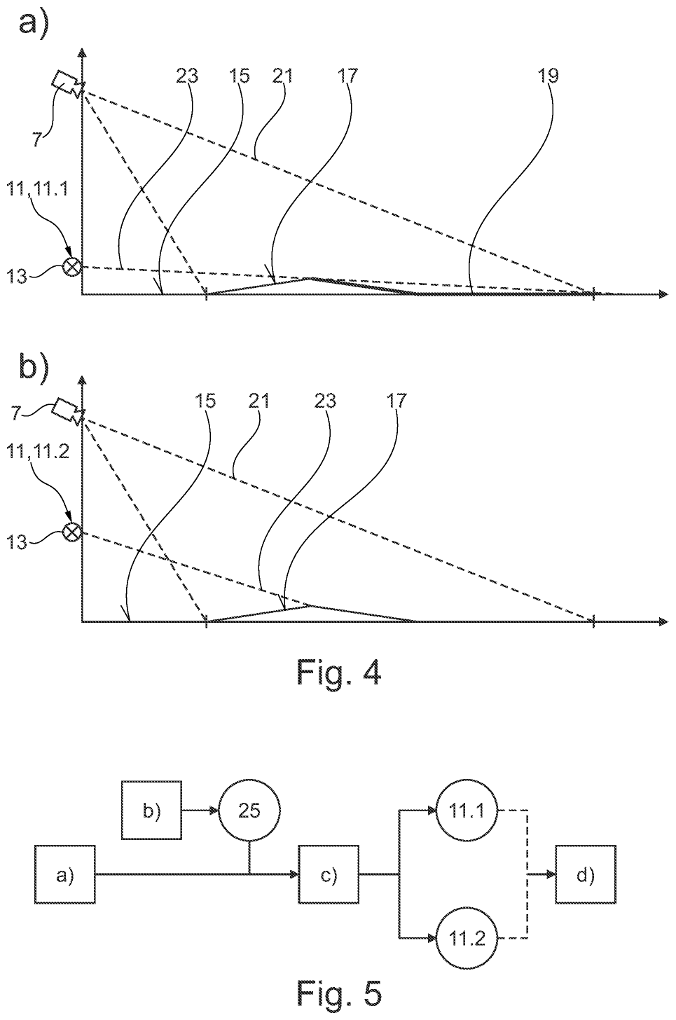

FIG. 4 shows a schematic representation of an illumination of a visible distance range from a first functional position and a second functional position, and

FIG. 5 shows a flowchart of an exemplary embodiment for operating an exemplary embodiment of a gated camera.

FIG. 1 shows a schematic representation of a first exemplary embodiment of a motor vehicle 1 with a gated camera 3. The gated camera 3 has at least one illumination device 5, in particular a first illumination device 5.1 and a second illumination device 5.2, an optical sensor 7 and a control device 9. The first illumination device 5.1 has at least two functional positions 11, in particular a first functional position 11.1 and a second functional position 11.2, so that a visible distance range can be illuminated by means of the at least one illumination device 5, in particular the first illumination device 5.1, optionally from at least one functional position 11 of the at least two functional positions 11. The at least two functional positions 11 are spatially, preferably vertically, distanced from one another.

The control device 9 is only shown schematically here and is operatively connected to the at least one illumination device 5, in particular the first illumination device 5.1 and the second illumination device 5.2, and the optical sensor 7 in a manner not explicitly shown and is set up for their respective control. In addition, a property 25 of the visible distance range is provided to the control device 9 in particular.

Preferably, the first illumination device 5.1 has at least two illumination elements 13, in particular a first illumination element 13.1 and a second illumination element 13.2. Particularly preferably, the first illumination element 13.1 is arranged in the first functional position 11.1. Alternatively or additionally, the second illumination element 13.2 is particularly preferably arranged in the second functional position 11.2. This means that the first illumination element 13.1 and the second illumination element 13.2 are spatially, in particular vertically, distanced from one another.

FIG. 2 shows a schematic representation of a second exemplary embodiment of the motor vehicle 1.

Identical and functionally identical elements are provided with the same reference signs in all figures, so that reference is made to the previous description in each case.

The gated camera 3 is preferably an extension of the gated camera 3 from FIG. 1.

The first illumination device 5.1 is designed analogously to the first illumination device 5.1 from FIG. 1.

In addition, the second illumination device 5.2 has at least two functional positions 11, in particular a third functional position 11.3 and a fourth functional position 11.4.

Preferably, the second illumination device 5.2 has at least two illumination elements 13, in particular a third illumination element 13.3 and a fourth illumination element 13.4. The third illumination element 13.3 is particularly preferably arranged in the third functional position 11.3. Alternatively or additionally, the fourth illumination element 13.4 is particularly preferably arranged in the fourth functional position 11.4.

In a preferred embodiment, two illumination elements 13, selected from the first illumination device 5.1 and the second illumination device 5.2, are controlled, in particular activated, simultaneously. Preferably, the first illumination element 13.1 and the third illumination element 13.3 or the second illumination element 13.2 and the fourth illumination element 13.4 are activated simultaneously. Alternatively, the first illumination element 13.1 and the fourth illumination element 13.4 or the second illumination element 13.2 and the third illumination element 13.3 are preferably activated simultaneously. Alternatively, the first illumination element 13.1 and the second illumination element 13.2 or the third illumination element 13.3 and the fourth illumination element 13.4 are preferably activated simultaneously.

In an alternative preferred embodiment, the illumination elements 13 of the first illumination device 5.1 and the second illumination device 5.2 are controlled, in particular activated, one after the other. Preferably, the first illumination element 13.1, the second illumination element 13.2, the third illumination element 13.3 and the fourth illumination element 13.4 are activated one after the other in a first chronological order. Alternatively, the first illumination element 13.1, the second illumination element 13.2, the fourth illumination element 13.4 and the third illumination element 13.3 are preferably activated one after the other in a second chronological order. Alternatively, the first illumination element 13.1, the third illumination element 13.3, the second illumination element 13.2 and the fourth illumination element 13.4 are preferably activated one after the other in a third chronological order. Alternatively, the first illumination element 13.1, the third illumination element 13.3, the fourth illumination element 13.4 and the second illumination element 13.2 are preferably activated one after the other in a fourth chronological order. Alternatively, the first illumination element 13.1, the fourth illumination element 13.4, the second illumination element 13.2 and the third illumination element 13.3 are preferably activated one after the other in a fifth chronological order. Alternatively, the first illumination element 13.1, the fourth illumination element 13.4, the third illumination element 13.3 and the second illumination element 13.2 are preferably activated one after the other in a sixth chronological order.

In a further alternative preferred embodiment, at least one illumination element 13, selected from the first illumination element 13.1, the second illumination element 13.2, the third illumination element 13.3 and the fourth illumination element 13.4, is preferably activated first, and at least one illumination element 13, selected from the first illumination element 13.1, the second illumination element 13.2, the third illumination element 13.3 and the fourth illumination element 13.4, is activated at a later time.

FIG. 3 shows a schematic representation of a third exemplary embodiment of the motor vehicle 1.

The gated camera 3 has the first illumination device 5.1 and the second illumination device 5.2.

Preferably, the first illumination device 5.1 only has a single illumination element 13, in particular the first illumination element 13.1. The first illumination element 13.1 can be moved between the first functional position 11.1 and the second functional position 11.2.

Alternatively or additionally, the second illumination device 5.2 preferably only has a single illumination element 13, in particular the third illumination element 13.3. The third illumination element 13.3 can be moved between the third functional position 11.3 and the fourth functional position 11.4.

In a preferred embodiment, the first illumination device 5.1 and the second illumination device 5.2 are controlled, in particular activated, one after the other or simultaneously. Preferably, when the first illumination device 5.1 is controlled, the first illumination element 13.1 is activated in at least one functional position, selected from the first functional position 11.1 and the second functional position 11.2. Alternatively or additionally, the third illumination element 13.3 is preferably activated in at least one functional position, selected from the third functional position 11.3 and the fourth functional position 11.4, when the second illumination device 5.2 is controlled.

FIG. 4 shows a schematic representation of an illumination of the visible distance range.

FIG. 4 a) shows a schematic representation of the illumination of the visible distance range from the first functional position 11.1.

A surface 15 to be observed, in particular a road to be observed, has a vertical deviation 17, in particular in the form of a hill, from a horizontal course. When the surface 15 is illuminated by means of an illumination element 13, which is arranged in the first functional position 11.1, the vertical deviation 15 casts a shadow 19, which at least partially covers an observation area 21 of the optical sensor. The shadow 19 is schematically determined here by means of a schematically depicted light beam 23. Thus, an object located to the right of the vertical deviation 15 lies completely in the shadow 19 and can therefore only be detected with difficulty using the optical sensor 7.

FIG. 4 b) shows a schematic representation of the illumination of the visible distance range from the second functional position 11.2.

The surface 15 to be observed, in particular the road to be observed, also has the vertical deviation 17, in particular in the form of the hill, from a horizontal course. When the surface 15 is illuminated by means of an illumination element 13, which is arranged in the second functional position 11.2, the vertical deviation 15 does not cast a shadow. The schematic determination of whether the vertical deviation 17 casts a shadow is also carried out here by means of a schematically depicted light beam 23. This means that even an object that is positioned to the right of the vertical deviation 15 can be easily detected by means of the optical sensor 7.

FIG. 5 shows a flow diagram of an exemplary embodiment for operating an exemplary embodiment of the gated camera 3.

Preferably, the control device 9 is set up to carry out a method described below.

In a first step a), the illumination device 5 and the optical sensor 7 are time-coordinated with each other, wherein a visible distance range is assigned to a first time coordination.

In a second step b), the property 25 of the visible distance range is provided. Preferably, a vertical deviation 17 of a surface 15 to be observed, in particular a road to be observed, from a horizontal course is used as the property 25 of the visible distance range.

In a third step c), a functional position 11 of the at least two functional positions 11 for illuminating the visible distance range is selected based on the property 25 of the visible distance range. Preferably, either the first functional position 11.1 or the second functional position 11.2 is selected.

In an optional fourth step d), the only illumination element 13 of the illumination device is preferably moved to the selected functional position 11 and activated. Alternatively, in the optional fourth step d), the first illumination element 13.1, which is arranged in the first functional position 11.1, or the second illumination element 13.2, which is arranged in the second functional position 11.2, is preferably controlled, in particular activated, based on the property 25 of the visible distance range.

1. Method for operating a gated camera (3) having an illumination device (5) and an optical sensor (7), wherein
the illumination device (5) and the optical sensor (7) are time-coordinated with each other, wherein
a visible distance range is assigned to a first time coordination, wherein
a property (25) of the visible distance range is provided, wherein
the illumination device (5) has at least two functional positions (11), so that the visible distance range can be selectively illuminated by means of the illumination device (5) from at least one functional position (11) of the at least two functional positions (11), wherein
the at least two functional positions (11) are spatially distanced from one another, wherein
based on the property (25) of the visible distance range, a functional position (11) of the at least two functional positions (11) for illuminating the visible distance range is selected.

2. Method according to claim 1, wherein the illumination device (5) has an illumination element (13), wherein the illumination element (13) is selectively displaced into one of the at least two functional positions (11) based on the property (25) of the visible distance range.

3. Method according to claim 1, wherein
the illumination device (5) has at least two illumination elements (13), wherein
a first illumination element (13.1) of the at least two illumination elements (13) is arranged in a first functional position (11.1) of the at least two functional positions (11), wherein
a second illumination element (13.2) of the at least two illumination elements (13) is arranged in a second functional position (11.2) of the at least two functional positions (11), wherein
based on the property (25) of the visible distance range, the first illumination element (13.1) or the second illumination element (13.2) is controlled to illuminate the visible distance range.

4. Method according to one of the preceding claims, wherein a vertical deviation (17) of a surface (15) to be observed, in particular a road to be observed, from a horizontal course is used as the property (25) of the visible distance range.

5. Method according to one of the preceding claims, wherein the at least two functional positions (11) are vertically distanced from one another.

6. Control device (9) for carrying out a method according to one of the preceding claims.

7. Gated camera (3) with an illumination device (5), an optical sensor (7) and a control device (9) according to claim 6, wherein the illumination device (5) has at least two functional positions (11), wherein the at least two functional positions (11) are spatially, in particular vertically, distanced from one another.

8. Gated camera (3) according to claim 7, wherein the illumination device (5) comprises an illumination element (13), wherein the illumination element (13) is displaceable between the at least two functional positions (11).

9. Gated camera (3) according to claim 7, wherein the illumination device (5) has at least two illumination elements (13), wherein the illumination elements (13) are arranged in one functional position (11) each.

10. Motor vehicle (1) with a gated camera (3) according to one of claims 7 to 9.
